(19) United States
(12) Patent Application Publication
(10) Pub. No.: US 2003/0076531 A1
(43) Pub. Date: Apr. 24, 2003

(54) Output terminal management server and output terminal function setting method

(75) Inventors: Masanori Kawasumi, Saitama-ken (JP); Shuichi Tsujimoto, Kanagawa-ken (JP); Yoshiaki Shimizu, Saitama-ken (JP); Mituaki Kouno, Chiba-ken (JP); Yuki Kamata, Tokyo (JP); Toshiaki Tanaka, Saitama-ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/252,822

(22) Filed: Sep. 24, 2002

(30) Foreign Application Priority Data
Oct. 18, 2001 (JP) 2001-320884

(51) Int. Cl. G06F 3/12; G06F 15/00

(52) U.S. Cl. 358/1.15; 710/16

(57) ABSTRACT

The output terminal management server of this invention is connected to at least one output terminal through a telecommunication line. This output terminal management server stores function setting data of output terminals by user using the output terminals. When a user inquiry is received from an output terminal, the output terminal management server searches the inquired user function setting data from the stored function setting data and sends the searched function setting data to the user inquiring output terminal. The output terminal is provided with a user recognition unit for recognizing users. An inquiry of a user that is recognized by the user recognition unit is sent to the output terminal management server. When the function setting data of that user are sent from the output terminal management server in response to the inquiry, the functions of that output terminal are set according to the received function setting data.

### BACKGROUND OF THE INVENTION

This invention relates to an output terminal management server that is used in a management system for output terminals of image forming apparatus, facsimile, printer or multi-functional peripheral with functions of these peripherals integrated into one unit and an output terminal function setting method.

Generally, substances of various functions such as number of copies, paper size; A4, A3, B5 and B4, magnifications for scaling-up and scaling-down of copy, copying on a single/both sides of both-sided paper from both-sided documents, copying density, etc. are optionally set by operating the operation panel of image forming apparatus. For these functions, default values are pre-registered based on standard using substances, and when the power source is turned on or reset, the set values will return to the default values.

Therefore, when an image forming apparatus is used according to standard substances to which settings of default values are PERTINENT, there will be no problem. However, when documents are not in standard paper quality as in copying press news, scaling-up or scaling-down is required, PERTINENT functions such as copy density, copy magnification, etc. were changed by operating the operation panel.

By the way, several users in an office normally share one image forming apparatus jointly. And depending on differences in substances of business, taste of individual persons, functions of that image forming apparatus are often changed to substances desired by users from default values. Therefore, an image forming apparatus is used according to standard substances for which setting of default values is PERTINENT and a user copies documents without aware of change in the function and a large amount of erroneous copies is generated. Further, there are many cases wherein the functions are changed to those functions desired by a user by operating the operation panel and once leaving from the apparatus after taking a first copy, the user takes a second copy for the same substances. However, if another user was taken copies by changing the functions between the first and second times, it was needed to change the functions again to the same functions as in the first time at the second time by operating the operation panel.

So far, for output terminals of image forming apparatus, etc., the functions having by these output terminals were set by a user as necessary. Therefore, when one output terminal is shared jointly by many users as in an office, it was unavoidable to reset the functions whenever the output terminal is used and fail to reset the functions as desired and thus, erroneous outputs are generated and efficiency are reduced.

### SUMMARY OF THE INVENTION

An object of this invention is to provide an output terminal management server that is used in an output terminal management system capable of reducing a time and labor to change functions of an output terminal to substances desired by users and suppressing generation of erroneous outputs.

Another object of this invention is to provide an output terminal function setting method that is capable of reducing a time and labor required to change functions of output terminals to substances desired by users and of suppressing generation of erroneous outputs.

According to this invention, an output terminal management server connected with at least one output terminal through a communication line is provided. The output terminal management serer comprises: storage means for storing function setting data of the output terminal by user who uses the output terminal; receiving means for receiving a user inquiry from the output terminal through the telecommunication line; searching means for searching user function setting data inquired from data stored by the storage means when a user inquiry is received by the receiving means from the output terminal; and sending means for sending the inquired user function setting data to the user inquiring output terminal through the telecommunication line when the setting data are detected by the searching means.

Further, according to this invention, an output terminal function setting method by an output terminal management server connected with at least one output terminal through the communication line is provided. The output terminal function setting method comprises: storing function setting data of the output terminal by user using the output terminal in advance in the storage unit of the output terminal management server; making the inquiry of a user to the output terminal management server by the output terminal when that user is recognized; searching an inquired user function setting data from the data stored in the storage means by the output terminal management server when the inquiry is received for the user from the output terminal; and setting functions of the output terminal by sending the function setting data to the user inquiring output terminal through the telecommunication line when the inquired user function setting data are detected.

### BRIEF DESCRIPTION OF THE DRAWINGS

FIG. 1 is a block diagram showing the system construction including an image forming apparatus management server in a preferred embodiment of this invention;

FIG. 2 is a block diagram showing the construction of principal portions of an image forming apparatus included in the system shown in FIG. 1;

FIG. 3 is a diagram showing a main table memory formed in a memory unit of an image forming apparatus shown in FIG. 2;

FIG. 4 is a block diagram showing the construction of the principal portions of an image forming apparatus management server;

FIG. 5 is a diagram showing principal data files that are formed in an HDD device of the image forming apparatus management server shown in FIG. 4;

FIG. 6 is a flowchart showing the principal portion of the process executed by a controller of the image forming apparatus shown in FIG. 2;

FIG. 7 is a flowchart of the principal portion of the user inquiry message receiving process executed by a CPU of the image forming apparatus management server shown in FIG. 4;

FIG. 8 is a flowchart showing the principal portions of an output log data message receiving process that is executed by the CPU of the image forming apparatus management server shown in FIG. 4; and

FIG. 9 is a diagram showing formats of messages exchanged between the image forming apparatus and the image forming apparatus management server.

### DETAILED DESCRIPTION OF THE INVENTION

A preferred embodiment of this invention will be explained below referring to the attached drawings.

Further, in this embodiment, an image forming apparatus is used as an output terminal.

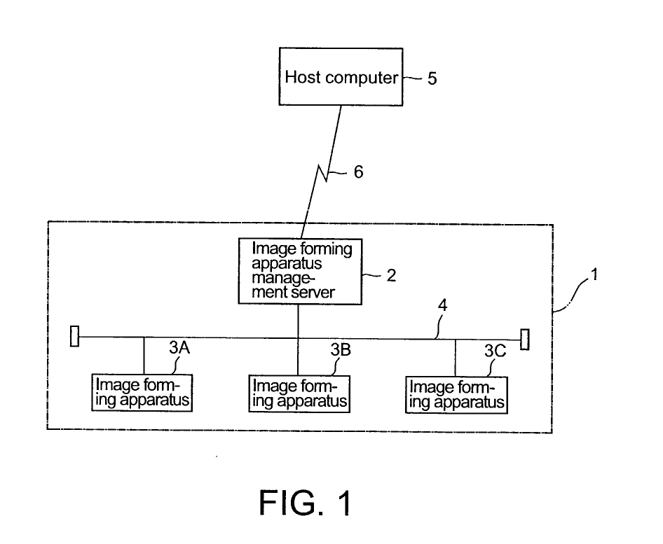

FIG. 1 is a block diagram showing the schematic construction of an image forming apparatus management system that is a preferred embodiment of an output terminal management system. This image forming apparatus management system 1 comprises plural units (3 units in FIG. 1) of image forming apparatus 3A, 3B and 3C connected to one image forming apparatus management server 2 by a LAN (Local Area Network) 4 that is a communication line in the mutual communication state. Further, the image forming apparatus management server 2 is connected with a host computer 5 that is available in a service center of an image forming apparatus manufacturer via an exclusive communication network or a WAN (Wide Area Network) 6 of a public telecommunication network.

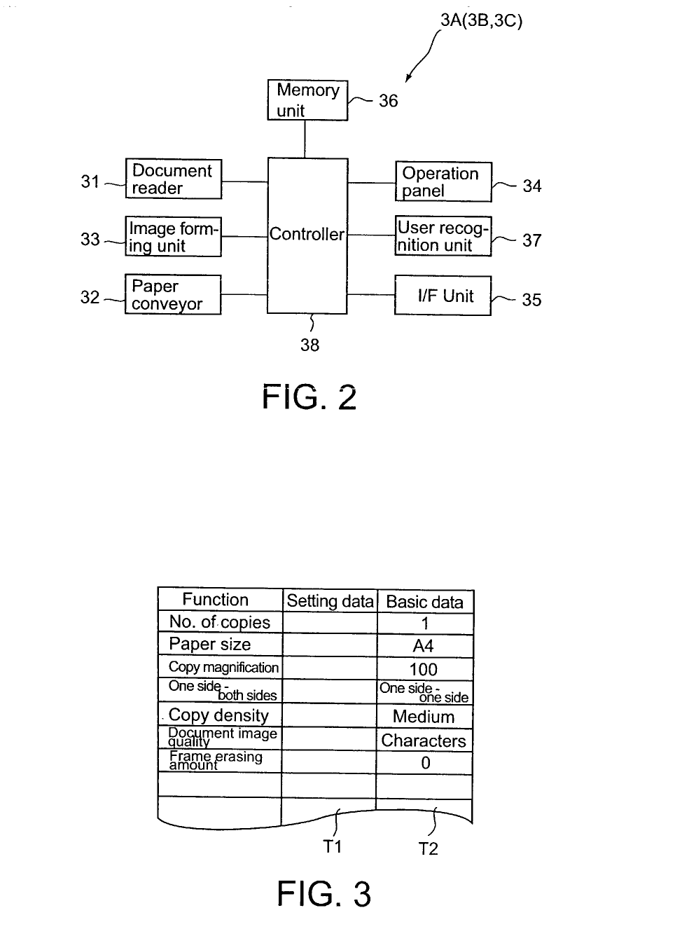

FIG. 2 is a block diagram showing the construction of principal portions, and the image forming apparatus 3A, 3B and 3C are in the same construction at least in the principal portions. That is, each of the image forming apparatuses 3A-3C is equipped with a document reader 31 for optically reading document images, a paper conveyor 32 for selectively conveying copy paper in various sizes; A4, A3, B5 and B4 sizes, and an image forming unit 33 for forming document images read by the document reader 31 on copy paper conveyed by the paper conveyor 32, respectively. Further, each image forming apparatus is also equipped with an operation panel 34 comprising a keyboard and a touch panel display, an I/F unit 35 that is connected to the LAN 4, a memory unit 36 for storing various data and a user recognition unit 37. The document reader 31, paper conveyor 32, image forming unit 33, operation panel 34, I/F unit 35, memory unit 36 and user recognition unit 37 are controlled by the controller 38 comprising a microcomputer.

The user recognition unit 37 recognizes users who use the image forming apparatus 3A-3C, and acquires user ID codes as the user recognizing means. For example, a fingerprint image of each user is stored and managed by assigning an unique ID code and a user ID code corresponding to the finger print image detected by a fingerprint detector is acquired as an ID code of a user who uses said image forming apparatus.

Further, when an image forming apparatus is connected to a personal computer (PC) and this image forming apparatus is used as a printer for that PC, the user recognition unit 37 accepts a user ID code input from that PC and recognizes a user who uses the image forming apparatus.

On a keyboard of the operation panel of the image forming apparatus 3A-3C in this structure, various kinds of function keys such as a start key to direct the start of image forming, a stop key to direct the stop of image forming, a reset key to direct the reset are arranged in addition to the ten-key to designate the number of copies. Further, substances of various functions of an image forming apparatus such as paper size, magnification of copy, density of copy, selection of one side/two sides modes, image quality of document, frame erasing amount can be set by operating the touch panel display of the operation panel 34.

Further, each of the image forming apparatus 3A˜3C has a function setting table T1 for temporarily storing various setting data of respective image forming apparatus and a default value table T2 with basic data of default values of various functions registered in advance in the memory unit 36 as shown in FIG. 3.

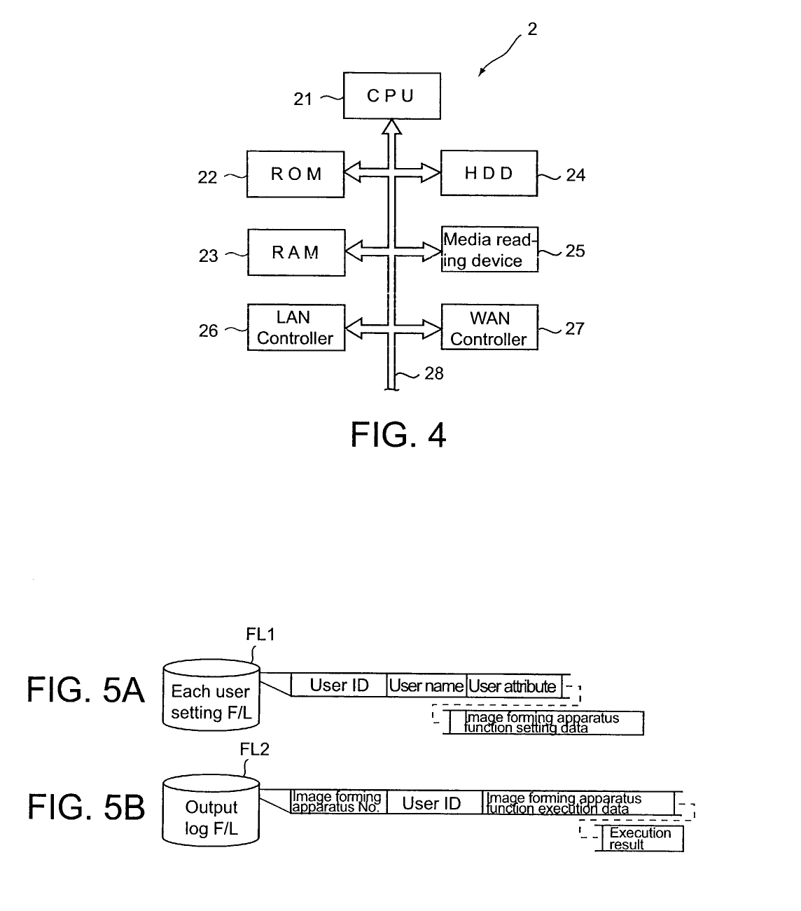

FIG. 4 is a block diagram showing the construction of principal portions of the image forming apparatus management server 2. The image forming apparatus management server 2 is composed mainly of such a computer as a personal computer or a workstation. That is, the image forming apparatus management server 2 is equipped with a CPU (Central Processing Unit) 21 as the main body of the controller. In addition, the server 2 is also provided with a ROM (Read Only Memory) 22 pre-storing fixed data such as programs, etc., a RAM (Random Access Memory) 23 in which areas are formed for storing various data so that the data can be rewritten, an HDD (Hard Disk Drive) 24 which functions as a non-volatile auxiliary memory, a media reading device 25 which reads such data as programs, etc. recorded on such computer readable recording media as flexible disk, optical disk (CD-ROM, CD-R, DVD, etc.), magnet-optical disk (MO, etc.), semiconductor memory card, etc., a LAN controller 26 which controls the data communication made through the LAN 4, and a WAN controller 27 which controls the data communication made through the WAN 6. The CPU 21 is connected to the ROM 22, RAM 23, HDD 24, media reader 25, LAN controller 26 and WAN controller 27 through such a bus line 28 as address bus, data bus, etc.

The image forming apparatus management server 2 constructed as described above forms an each user setting file FL1 in its HDD 24 as a function setting data storage means for storing name and attribute of user (belonging, post, etc. in office) by ID code of each user and setting data for each function of the image forming apparatus 3A-3C as shown in FIG. 5A.

Also, an output log file FL2 is formed in the same HDD for accumulating and storing output log data comprising Image Forming Apparatus No., user ID code, image forming apparatus function execution data, execution results collected from the image forming apparatus 3A-3C as shown in FIG. 5B. In this connection, Image Forming Apparatus No. is a unique number pre-assigned to each image forming apparatus 3A˜3C.

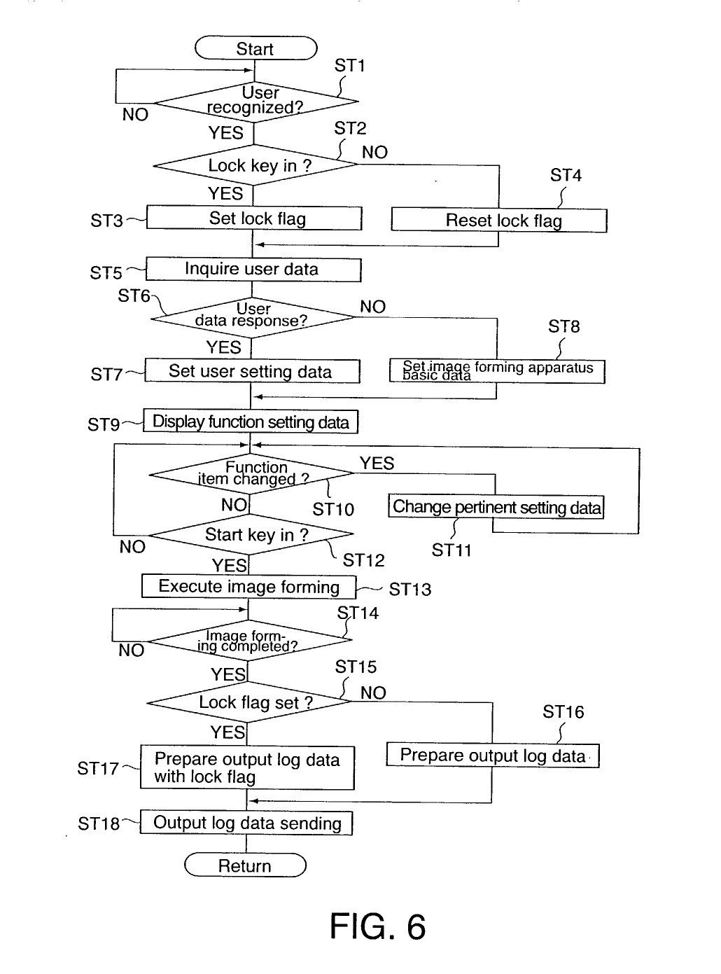

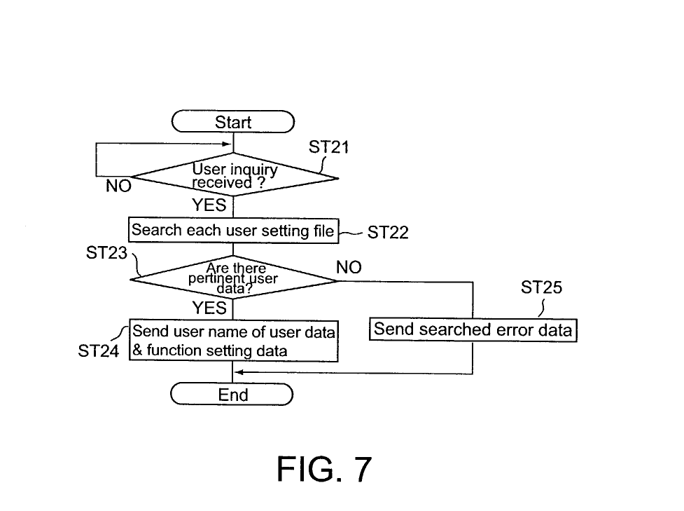

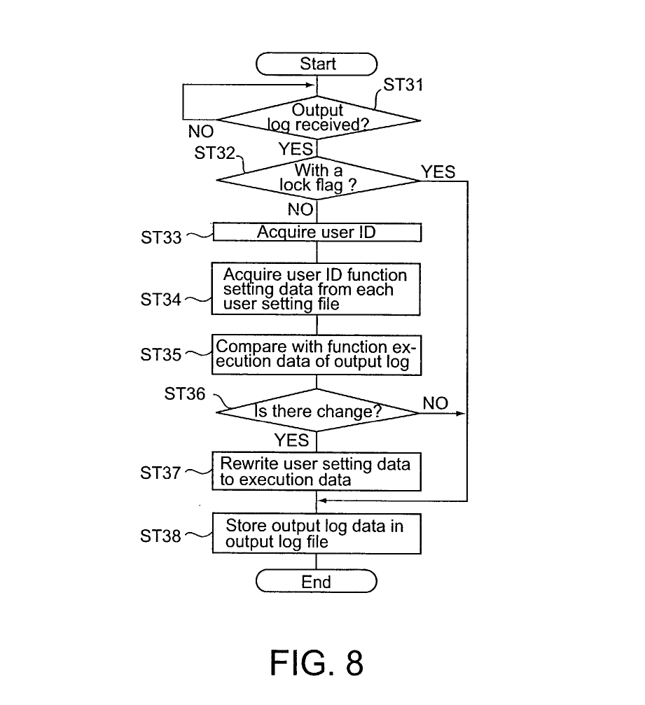

The image forming apparatus management system 1 comprising the image forming apparatus management server 2 and the image forming apparatus 3A-3C connected by the LAN 4 executes the processing steps shown in the flowchart in FIG. 6 repeatedly by the controller 38 of each image forming apparatus 3A-3C. Further, in proportion to the process executed by each image forming apparatus 3A-3C, the CPU 21 of the image forming apparatus management server 2 executes the processing steps shown in the flowcharts in FIG. 7 and FIG. 8 based on the image forming apparatus function setting program installed in the HDD 24.

That is, the controller 38 of each image forming apparatus 3A-3C waits the recognition of a user ID code of a user utilizing the image forming apparatus by the user recognition unit 37 in ST (Step) 1. Then, when the user ID code is recognized, the controller 38 judges whether a lock key provided on the keyboard of the operation panel 34 is input in ST2. Here, when the lock key is input, a lock flag of the memory unit 36 is set in ST3 and when the lock key is not input, the lock flag is reset in ST4. The lock key is a key to show that user settings are not changed. Therefore, when the user settings are set and the printing is carried out as shown in the substances of the settings, the lock key should not be depressed.

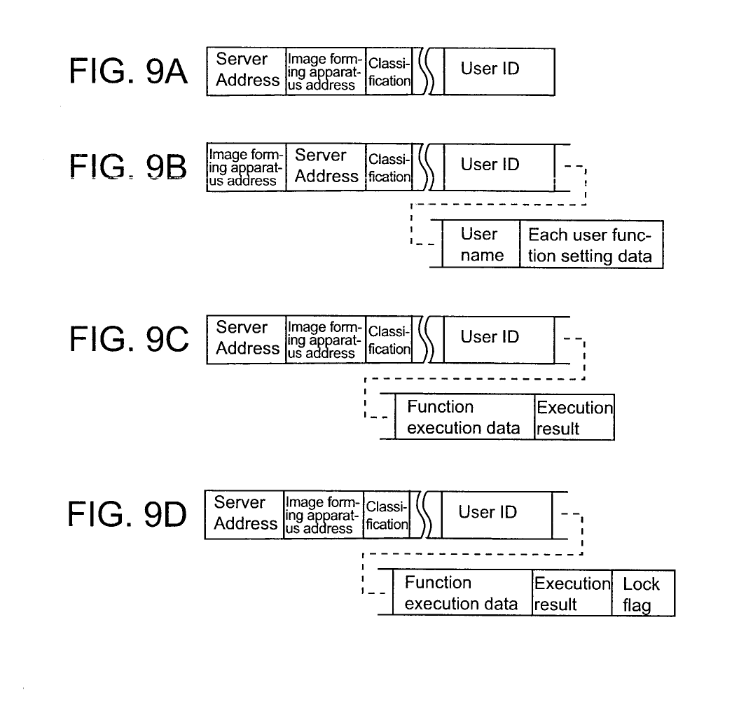

Then, the controller 38 prepares a user data inquiry message in the format shown in FIG. 9A in ST5. That is, the controller 38 prepares a message by setting a communication address of the image forming apparatus management server 2 as a “Receiver Address” and a communication address of an PERTINENT image forming apparatus 3A˜3C as a “Sender Address” and further, a code showing the user data inquiring message as a “Classification Code”, and a user ID code recognized by the user recognition unit 37 as a “Data Text”. Then, this user data inquiry message is sent to the image forming apparatus management server 2 via the LAN 4 connected to the I/F unit 35 (the user inquiring means). Thereafter, the controller 38 waits a response from the image forming apparatus management server 2.

On the other hand, the CPU 21 of the image forming apparatus management server 2 which received a user data inquiring message from one of the image forming apparatus 3A˜3C connected by the LAN 4 (the inquiry receiving means) in ST21 searches the each user setting file FL1 using a user ID code in the received message as the searching key in ST22 when detected that the user data inquiring message is received in ST21 (the data searching means).

As a result, when detecting that such user data as user name, user attribute, image forming apparatus function setting data were set in the each user setting file FL 1 corresponding to a user ID code which is the searching key in ST23, the user name and the image forming apparatus function setting data are read out in ST24. Then, a user data response message in the format shown in FIG. 9B is prepared. That is, the communication address of the user data inquiry message sending image forming apparatus 3A-3C is set as the “Receiver Address” and the communication address of the image forming apparatus management server 2 is set as the “Sender Address”. Further, a code showing a user data response message is set as the “Classification Code” and the user name and the image forming apparatus function setting data read from the each user setting file FL1 in addition to the user ID code contained in the user data inquiry message are set as the “Data Text”, and a user data response message is prepared. Then, this user data response message is sent to one of the image forming apparatus 3A-3C, which is the user data inquiry message sender via the LAN 4 (the function setting data sending means).

Further, when a user ID code as a searching key was not set in the each user setting file FL1, a searching error data message with an error code showing a prescribed searching error included in addition to the user ID code contained in the user data inquiry message is prepared as the “Data Text” in the same format as the user data response message. This searching error data message is sent to one of the image forming apparatus 3A˜3C, which is the user data inquiry message sender via the LAN 4.

When a user data response message is received in ST6, the controller 38 of one of the image forming apparatus 3A˜3C, which sent the user data inquiry message in the process in ST5 as shown in FIG. 6, will set the image forming apparatus function setting data contained in the user data response message in the function setting table T1 by item in ST7 (the function setting means). On the other hand, when the user data response message could not be received in ST6, the basic data that are set in the default value table T2 are set in the function-setting table T1 by item.

Thereafter, the substances of the image forming apparatus functions that are set in the function setting table T1 are displayed on the operation panel 34 in ST9. Then, the change of the image forming apparatus functions is accepted. Here, when the substance of any function was changed by the input to the operation panel 34 in ST10, data of pertinent function in the function setting table T1 is changed in response to the substance of the change in ST11 (the function changing means). For example, when the number of copies is changed to 10 sheets by the ten-key on the operation panel in the state wherein Data “1” is set for Item “No. of Copies” on the function setting table T1, that is, the number of sheets displayed is one sheet, the data corresponding to Item “No. of Copies” on the function setting table T1 is changed to “10”. Similarly, when the paper size is changed to B5 by operating the ten-key on the operation panel in the state wherein the data “A4” is set corresponding to Item “Paper Size” on the function setting table T1, that is, A4 size is displayed as the paper size, the data corresponding to Item “Paper Size” on the function setting table T1 is changed to “B5”.

Further, when the controller 38 detects that the start key on the operation panel is operated in the state wherein the change of the image forming apparatus function items is accepted in ST12, the controller 38 executes the image forming operation by controlling the document reader 31, the paper conveyer 32 and the image forming unit 33 based on the substances of various functions set on the function setting table T1 in ST13.

Thereafter, when the completion of the image forming operation is detected in ST14, the controller 38 judges if the lock flag is set in ST15. Here, if the lock flag was not set, an output log data in the format shown in FIG. 9C is prepared in ST16. That is, the communication address of the image forming apparatus management server 2 is set as the “Receiver Address” and the communication address of the pertinent image forming apparatus 3A-3C as the “Sender Address”. Further, a code showing an output log data message is set as the “Classification Code” and by setting the user ID code recognized by the user recognition unit 37 as the “Data Text”, various function data set on the function setting table T1 and the image formation execution result (presence of errors in the number of copies, paper jam, etc.), an output log data message is prepared.

When the lock flag was set in ST15, an output log data with a lock flag in the format shown in FIG. 9D is prepared in ST17. That is, an output log data message with a lock flag is prepared by setting the log flag in “Data Text” pf the output log data message shown in FIG. 9C.

When an output log data message is thus prepared in ST16 or ST17, this output log data message is then sent to the image forming apparatus management serve 2 via the LAN 4 in ST18. Thereafter, returning to ST1, the recognition of a user ID code is waited.

On the other hand, after receiving an output log data message from one of the image forming apparatus 3A-3C in ST31 as shown in FIG. 8, the CPU 21 of the image forming apparatus management server 2 judges whether the received message has a lock flag attached in ST32.

Here, if the output log data message has no lock flag attached, a user ID code contained in this received message is acquired in ST33. Then, by searching the each user setting file FL1 using this user ID code as a searching key, the image forming apparatus function setting data that is set corresponding to the pertinent user ID code is acquired in ST34. Then, the image forming apparatus function setting data acquired from the each user setting file FL1 are compared with the image forming apparatus function execution data contained in the received message for each item, it is judged whether the image forming apparatus function setting data sent to one of the image forming apparatus 3A˜3C in which the user ID code is recognized are changed on the image forming apparatus in ST35 (the change presence judging means).

When the presence of any change is judged as a result in ST36, the image forming apparatus function set data that were set corresponding to the user ID code on the each user setting file FL1 are rewritten to the image forming apparatus function execution data in the received message in ST37 (the function data updating means). When judged that there is no change in ST36, the process in ST37 is not executed.

Thereafter, the output log data comprising a user ID code contained in a received message, an image forming apparatus function execution data and an execution result are stored in the output log file FL2 together with the Image Forming Apparatus Number of pertinent image forming apparatus 3A-3C specified by the image forming apparatus address in the message in ST38.

Further, when the received message was an output log data message with a lock flag in ST32, the lock is applied not to change the image forming apparatus function setting data that are set corresponding to an pertinent user ID code and therefore, proceeding to the process in ST38, only the process is executed to store the output log data comprising the user ID code in the received message, the image forming apparatus function execution data and the executed result in the output log file FL2 together with Image Forming Apparatus No. 3A-3C specified by an image forming apparatus address contained in the message.

As described above, in this embodiment, when a user intends to use, for example, the image forming apparatus 3A and the user ID code of that user is recognized by the user recognition unit 37 of this image forming apparatus 3A, a user data inquiring message is sent to the image forming apparatus management server 2 from this image forming apparatus 3A. Thus, in the image forming apparatus management server 2, the each user setting file FL1 is searched. And when the user ID code of that user is set, a user data response message including the image forming apparatus function set data, etc. corresponding to that user ID code is prepared and sent to the image forming apparatus 3A. As a result, the image forming apparatus function setting data of that user will be set in the function setting table T1 of the image forming apparatus 3A.

Here, when a user depresses the start key without changing the functions utterly, the image forming operation is executed according to the image forming apparatus function setting data of that user that are set in the each user setting file FL1. Then, after the image forming operation is completed, an output log data message is prepared based on the result of this execution and sent to the image forming apparatus management server 2. And the image forming apparatus function execution data in the output log data message are compared with the image forming apparatus function setting data of that user that are set in the each user setting file FL1. In this case, as the image forming apparatus function execution data and the image forming apparatus setting data agree with each other, the image forming apparatus function setting data of that user in the each user setting file FL1 will not be changed.

On the contrary, when assuming that the image forming was executed by a user after changing the image forming apparatus function setting “Paper Size” from A4 size to B4 size and “Copying Magnification” to 100% from 120% by operating the operation panel 34, in the image forming apparatus management server 2, the image forming apparatus function execution data does not agree with the image forming apparatus function setting data and the image forming apparatus function setting data are rewritten to the image forming apparatus function execution data of that user in the each user setting file FL1. That is, the image forming apparatus function item “Paper Size” is rewritten to B4 size and “Copying Magnification” is rewritten to 120%.

Thereafter, when this user intends to use, for example, the image forming apparatus 3B, the image forming apparatus function setting data of that user, that is, the image forming apparatus function execution data when the user executed the image formation using the image forming apparatus 3A immediately before will be set in the function setting table T1 of this image forming apparatus 3B. Accordingly, when the image forming is executed in the same conditions as those when executed the image forming using the image forming apparatus 3A, a user is able to execute the image forming instantly without changing the image forming apparatus functional items.

Thus, according to this invention, when executing the image forming operation at least in the same conditions as in the image forming lastly executed, each user is not needed to change the image forming apparatus functions even when any image forming apparatus is used and it is therefore possible to reduce a time and labor to change the image forming apparatus functions. Accordingly, users who execute the image forming always under the same conditions are not required at all to change the image forming apparatus functions even when the substances of the image forming apparatus functions corresponding to those conditions differ largely from the standard substances.

By the way, in this embodiment, a lock key is provided to each image forming apparatus 3A-3C. When a user is recognized in the state with this lock key depressed, an output log data message sent to the image forming apparatus management server 2 after executing the image forming operation become data with a lock flag attached. In this case, even when a user changed the substances of the image forming apparatus functions manually, the image forming apparatus function setting data before the manual change by the user will not be changed to the image forming apparatus function execution data after the manual change in the image forming apparatus management server 2.

Accordingly, when a user who always executes the image forming in the same conditions changes the image forming apparatus function items for executing the image forming temporarily in other conditions, it becomes possible to prevent the image forming apparatus function execution data of this time from reflecting in the image forming apparatus function setting data of the user by depressing the lock key.

By the way, in this embodiment whenever the image forming operation is executed in the image forming apparatus 3A-3C, the output log data is sent to the image forming apparatus management server 2. In the image forming apparatus management server 2, the output log data received from the image forming apparatus 3A-3C are accumulated by each image forming apparatus in the output log file FL2.

Accordingly, in the hoist computer 5 connected to the image forming apparatus management server 2 via the WAN 6, it is possible to grasp the working status of the image forming apparatus 3A-3C by collecting and analyzing output log data accumulated in the output log file FL2 by image forming apparatus. So, by compiling this working status in a report and providing to an office, it is possible to direct efficient number of units and arrangement, etc. of image forming apparatus.

Further, this invention is not limited to the embodiment presented above.

For example, output terminals are assumed to be image forming apparatus in the embodiment described above but this invention is also pertinent to a printer, facsimile or a multi-functional peripheral which integrated the functions of these units in one unit. In this connection, in the case of a facsimile, an abbreviated dialing number list shall be set in an output terminal management server. Thus, a user is able to make the facsimile transmission using the abbreviated dial number list of independent user even when using any facsimile available in an office.

Further, the embodiment shown above is one example to manage the image forming apparatus 3A-3C in one office by the image forming apparatus management server 2 but plural units of output terminals in offices scattered in different areas may be managed by one unit of output terminal management server. Thus, a time and labor for a user to reset substances of image forming apparatus functional items becomes unnecessary even when the user is always making the copy in the same conditions by moving to another office.

Further, needless to say, the number of units of output terminals that are managed by the output terminal management server is not limited to 3 units but can be two units or more than 4 units. In addition, this invention is pertinent to a case wherein one unit of output terminal is managed by one unit of output terminal management server.

In the above embodiment, a case to use a fingerprint is presented as an example of the user recognition unit 37 but the user recognition method is not limited to this method. For example, the iris of pupil of the eye and a voiceprint are also usable to recognize a user. Further, each user carries a wireless communication card recording a user ID code and a wireless receiver is provided to an output terminal (a copier, facsimile, a printer, a multi-functional peripheral, etc.). Thus, when a user comes close to an output terminal to use it, the user ID code is received from the user wireless communication card so that the user can be recognized. Further, this invention includes a case wherein a user is recognized when a user inputs own user ID code through the keyboard of the operation panel 34.

Further, in the above embodiment, the image forming apparatus management server 2 reads an image forming apparatus function setting program from a recording medium and installs it in the HDD device 24. The image forming apparatus management server 2 may have the image forming apparatus function setting program pre-stored in the ROM 22. In addition, the program may not be read from a recording medium but may be downloaded from a network through the interface.

As described above in detail, according to this invention, it is possible to provide an output terminal management server capable of reducing a time and labor for changing functions of an output terminal to substances desired by a user and suppressing generation of erroneous output. Further, it is possible to manage the state of service life of a photosensitive drum and exhaust of toners as the working status of an output terminal. Further, there is such an effect that a consulting service is provided to use of an output terminal, e.g., an image forming apparatus.

In addition, it is also possible to provide an output terminal function setting method capable of reducing a time and labor for changing the functions of the output terminal to substances desired by a user and suppressing generation of erroneous output.

What is claimed is:

1. An output terminal management server connected with at least one unit of output terminal through a telecommunication line, comprising:
storage means for storing function setting data of the output terminal by user who uses the output terminal;
receiving means for receiving a user inquiry from the output terminal through the telecommunication line;
searching means for searching user function setting data inquired from data stored by the storage means when a user inquiry is received by the receiving means from the output terminal; and
sending means for sending the inquired user function setting data to the user inquiring output terminal through the telecommunication line when the setting data are detected by the searching means.

2. The output terminal management server according to claim 1, further comprising:
judging means for judging whether the function setting data sent to the output terminal by the sending means are changed at the output terminal; and
updating means for rewriting the user function setting data stored in the storage means to the changed data when the judging means judges that the function setting data are changed.

3. The output terminal management server according to claim 2, wherein the updating means includes judging means for judging whether the change of the pertinent user function setting data stored in the storage means is approved.

4. The output terminal management server according to claim 3, wherein the pertinent user function setting data are not changed when the judging means judges that the function setting data should not be changed.

5. An output terminal function setting method by an output terminal management connected with at least one unit of output terminal through a telecommunication line, comprising:
storing function setting data of the output terminal by user using the output terminal in advance in the storage unit of the output terminal management server;
making the inquiry of a user to the output terminal management server by the output terminal when that user is recognized;
searching an inquired user function setting data from the data stored in the storage means by the output terminal management server when the inquiry is received for the user from the output terminal; and
setting functions of the output terminal by sending the function setting data to the user inquiring output terminal through the telecommunication line when the inquired user function setting data are detected.

6. The output terminal function setting method according to claim 5, further comprising the steps of:
judging whether the function setting data are changed at the user inquiring output terminal by the output terminal management server which sent that user function setting data; and
rewriting the function setting data of the user stored in the storage unit to the changed data when the data are changed.

7. The output terminal function setting method according to claim 5, further comprising:
judging whether user function setting data are changed at an user inquiring output terminal by the output terminal management server which sent the user function setting data to a user inquiring output terminal; and
judging whether the change of pertinent user function setting data stored in the storage unit is approved when the user function setting data are changed.

8. The output terminal function setting method according to claim 7, wherein the pertinent user function setting data are rewritten to the data after changed when the change of the user function setting data was approved in the judging step.

9. The output terminal function setting method according to claim 7, wherein the pertinent user function setting data will not be changed when judged that the change was not approved in the judging step.
